(19) United States
(12) Patent Application Publication
(10) Pub. No.: US 2012/0020714 A1
(43) Pub. Date: Jan. 26, 2012

(54) APPARATUS AND METHOD FOR REDUCING FUSER NOISE IN A PRINTING APPARATUS

(75) Inventors: George Cunha CARDOSO, Webster, NY (US); Faming Li, Penfield, NY (US)

(73) Assignee: XEROX CORPORATION, Norwalk, CT (US)

(21) Appl. No.: 12/842,443

(22) Filed: Jul. 23, 2010

(51) Int. Cl. G03G 15/00

(52) U.S. Cl. 399/400

(57) ABSTRACT

An apparatus and method that reduces fuser noise in a printing apparatus. The method can include generating a first image on a first media sheet traveling in a media path. The method can include generating a second image on a second media sheet traveling in the media path consecutive to and a first distance from the first media sheet. The method can include reducing the first distance between the first media sheet and the second media sheet to a second distance between the first media sheet and the second media sheet after generating the first image. The method can include fusing the second image to the second media sheet after reducing the first distance between the first media sheet and the second media sheet.

### BACKGROUND

Disclosed herein is an apparatus and method that reduces fuser noise in a printing apparatus.

Presently, image output devices, such as printers, multifunction media devices, xerographic machines, ink jet printers, and other devices produce images on media sheets, such as paper, substrates, transparencies, plastic, labels, or other media sheets. To produce an image, marking material, such as toner, ink jet ink, or other marking material, is applied to a media sheet to create a latent image on the media sheet. A fuser assembly then affixes or fuses the latent image to the media sheet by applying heat and/or pressure to the media sheet.

Fuser assemblies apply pressure using rotational members, such as fuser rolls or belts that are coupled to each other at a fuser nip. Pressure is applied to the media sheet with the latent image as the media sheet is fed through the fuser nip. Unfortunately, the feeding of cut-sheet pages into a hard roll fuser nip under high pressure produces undesirable audible noise due to the hard impact at the beginning and end of an interdocument zone. This audible noise in a hard roll fuser, such as a warm pressure fuser or a cold pressure fuser, is much louder than in conventional fusers due to the lack of conformity of the hard rolls. The noise reaches unacceptable levels for office use when the engine is running at high speed. This noise arises from the very low conformability between a hard fuser roll, paper, and a hard pressure roll. This gives rise to a sudden force applied in a very short time after a media sheet edge due to a lack of the conformability of the rolls. The resulting impulse wave includes many frequency components that vibrate the fuser structure at most of its natural frequencies causing the undesirable noise.

Thus, there is a need for an apparatus and method that reduces fuser noise in a printing apparatus.

### SUMMARY

An apparatus and method that reduces fuser noise in a printing apparatus is disclosed. The method can include generating a first image on a first media sheet traveling in a media path. The method can include generating a second image on a second media sheet traveling in the media path consecutive to and a first distance from the first media sheet. The method can include reducing the first distance between the first media sheet and the second media sheet to a second distance between the first media sheet and the second media sheet after generating the first image. The method can include fusing the second image to the second media sheet after reducing the first distance between the first media sheet and the second media sheet.

### BRIEF DESCRIPTION OF THE DRAWINGS

In order to describe the manner in which advantages and features of the disclosure can be obtained, a more particular description of the disclosure briefly described above will be rendered by reference to specific embodiments thereof, which are illustrated in the appended drawings. Understanding that these drawings depict only typical embodiments of the disclosure and do not limit its scope, the disclosure will be described and explained with additional specificity and detail through the use of the drawings in which:

FIG. 1 is an exemplary first view illustration of a printing apparatus;

FIG. 2 is an exemplary second view illustration of a printing apparatus, where the second view is orthogonal to the first view; and

FIG. 3 illustrates an exemplary flowchart of a method in a printing apparatus.

### DETAILED DESCRIPTION

The embodiments include a method that reduces fuser noise in a printing apparatus having a media path, an image generator, and a fuser. The method can include generating, using the image generator, a first image on a first media sheet traveling in the media path. The method can include generating, using the image generator, a second image on a second media sheet traveling in the media path consecutive to and a first distance from the first media sheet. The method can include reducing the first distance between the first media sheet and the second media sheet to a second distance between the first media sheet and the second media sheet after generating the first image. The method can include fusing the second image to the second media sheet after reducing the first distance between the first media sheet and the second media sheet.

The embodiments further include a printing apparatus that reduces fuser noise. The printing apparatus can include a media path configured to transport a first media sheet and a second media sheet consecutive to the first media sheet. The printing apparatus can include an image generator configured to generate a first image on the first media sheet traveling in the media path and configured to generate a second image on the second media sheet traveling in the media path consecutive to and a first distance from the first media sheet. The printing apparatus can include a controller configured to control the printing apparatus to reduce the first distance between the first media sheet and the second media sheet to a second distance between the first media sheet and the second media sheet after generating the first image. The printing apparatus can include a fuser configured to fuse the second image to the second media sheet after the first distance is reduced between the first media sheet and the second media sheet.

The embodiments further include a method that reduces fuser noise in a printing apparatus having a media path, a rotational intermediate transfer member, an image transfer station, and a fuser. The method can include placing marking material on the rotational intermediate transfer member to generate a first image. The method can include placing marking material on the rotational intermediate transfer member to generate a second image spaced an interdocument zone distance from the first image. The method can include transferring the first image from the rotational intermediate transfer member to a first media sheet traveling in the media path. The method can include transferring the second image from the rotational intermediate transfer member to a second media sheet consecutive to the first media sheet, the second media sheet traveling in the media path a first distance from the first media sheet, the first distance corresponding to the interdocument zone. The method can include reducing the first distance between the first media sheet and the second media sheet to a second distance between the first media sheet and the second media sheet after generating the first image. The method can include fusing the second image to the second media sheet after reducing the first distance between the first media sheet and the second media sheet.

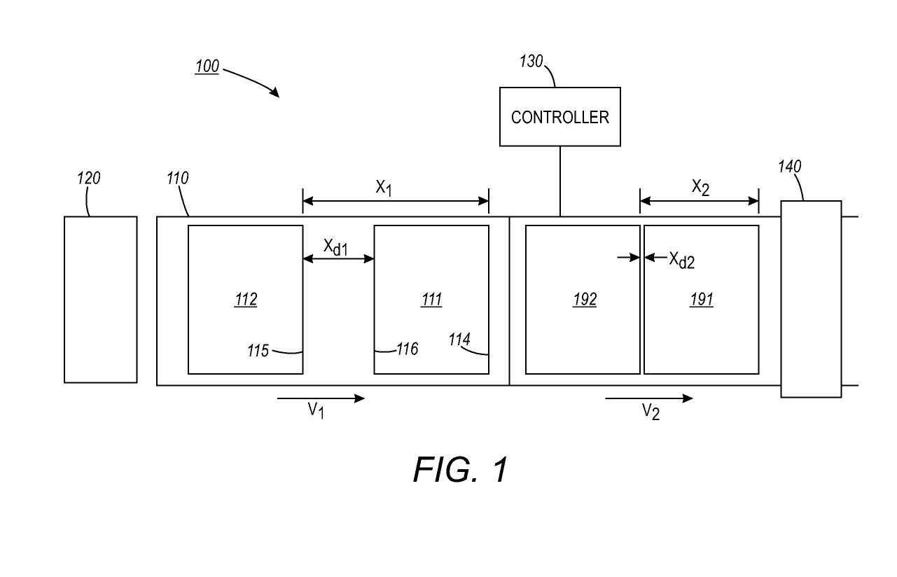

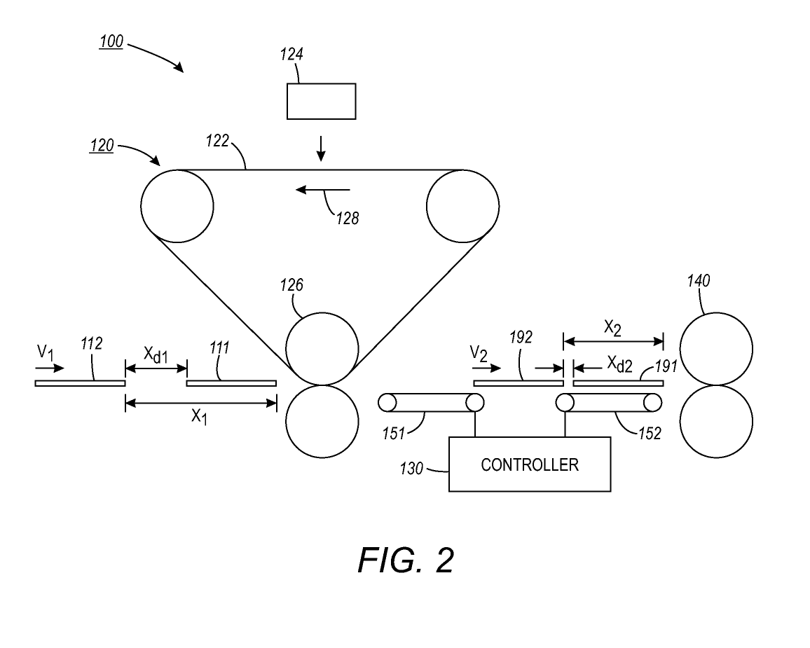

FIG. 1 is an exemplary first view illustration of a printing apparatus 100. FIG. 2 is an exemplary second view illustration of a printing apparatus 100, where the second view is orthogonal to the first view. The illustrations are not necessarily drawn to scale. The printing apparatus 100 may be a printer, a multifunction media device, a xerographic machine, a laser printer, an ink jet printer, or any other device that generates an image on media sheets. The printing apparatus 100 can include a media path 110 configured to transport a first media sheet 111. The media path 110 can transport and a second media sheet 112 consecutive to the first media sheet 111.

The printing apparatus 100 can include an image generator 120 configured to generate a first image on the first media sheet 111 traveling in the media path 110 and configured to generate a second image on the second media sheet 112 traveling in the media path 110 consecutive to and a first distance x_{d1} from the first media sheet 111. The second image generated on the second media sheet 112 can be the same image as the first image generated on the first media sheet 111. The image generator 120 can generate the first image on the first media sheet 111 traveling in the media path 110 at a first velocity v₁ and can generate the second image on the second media sheet 112 traveling in the media path 110 at the first velocity v₁.

The printing apparatus 100 can include a controller 130 configured to control the printing apparatus 100 to reduce the first distance x_{d1} between the first media sheet 111 and the second media sheet 112 to a second distance x_{d2} between the first media sheet 191 and the second media sheet 192 after generating the first image. Element numbers 191 and 192 are used to designate later positions of the first media sheet 111 and the second media sheet 112 in the media path 110. There can also be additional media sheets traveling in the media path 110 and distances can also be reduced for the additional media sheets. The controller 130 can control the printing apparatus 100 to reduce the first velocity v₁ of the first media sheet 111 to a second velocity v₂ after generating the first image. The first velocity v₁ of the first media sheet 111 and the second media sheet 112 can be reduced to account for reducing the distance between the first media sheet 191 and the second media sheet 192.

For example, the image generator 120 can generate the second image on the second media sheet 112 consecutive to the first media sheet 111 where the first media sheet 111 and the second media sheet 112 can travel in the media path 110 at the first velocity v₁ at a first distance x_{d1} between them. The controller 130 can then control the printing apparatus 110 to reduce the first velocity v₁ of at least the first media sheet 111 to the second velocity v₂ after generating the first image. The first velocity v₁ of the first media sheet 111 can be reduced to a second velocity v₂ according to a formula based on at least:

v₁/v₂=x₁/x₂

Where v₁ can be the first velocity, v₂ can be the second velocity, x₁ can be a first length corresponding to the first distance x_{d1} between the first media sheet 111 and the second media sheet 112, and x₂ can be a second length corresponding to the second distance x_{d2} between the first media sheet 191 and the second media sheet 192. The first length x₁ can be determined based on a distance between a leading edge 114 of the first media sheet 111 and a leading edge 115 of the second media sheet 112. A first length can also be determined based on a distance between a trailing edge 116 of the first media sheet 111 and a leading edge 115 of the second media sheet 112 or can be determined based on any other useful relative distance between the media sheets. The second length x₂ can similarly be determined based on any useful relative distance between the media sheets.

The printing apparatus 100 can include a fuser 140 configured to fuse the second image to the second media sheet 192 after reducing the first distance x_{d1} between the first media sheet 191 and the second media sheet 192. The first image can also be fused to the first media sheet 191 after reducing the first distance x_{d1} between the first media sheet 191 and the second media sheet 192. The fuser 140 can fuse the first image to the first media sheet 191 traveling at the second velocity v₂ after the controller 130 reduces the first velocity v₁ of the first media sheet 111 to the second velocity v₂. The second image can be fused to the second media sheet 192 after reducing the velocity v₁ of the second media sheet 112. The fuser 140 can include a first roll including a vibration damping material. For example, the first roll can be a warm pressure fuser roll, a cold pressure fuser roll, a heated fuser roll, a pressure roll, a drum, or any other roll that can fuse an image to a media sheet. The vibration damping material can be sand, a granular material, or any other material that can reduce vibration of a fuser roll.

According to one embodiment, the controller 130 can control the printing apparatus 100 to reduce the first distance x_{d1} between the first media sheet 111 and the second media sheet 112 to a second distance x_{d2} between the first media sheet 191 and the second media sheet 192 after generating the first image to reduce vibration of the fuser 140 occurring between a trailing edge 116 of the first media sheet 111 and a leading edge 115 of the second media sheet 112. The controller 130 can also control the printing apparatus to reduce the first distance x_{d1} between the first media sheet 111 and the second media 112 sheet to a second distance x_{d2} between the first media sheet 191 and the second media sheet 192 after generating the first image to reduce a length x_{d1} of an interdocument zone between the first media sheet 111 and the second media sheet 112 after generating the first image. For example, the interdocument zone can be used for printing apparatus operations. As a further example, the interdocument zone can be used for cleaning printing apparatus elements, for placement of test patches on intermediate transfer rolls or belts, for process control, and for other printing apparatus operations.

The image generator 120 can include a rotational intermediate transfer member 122. The rotational intermediate transfer member 122 can be an intermediate transfer belt, can be an intermediate transfer roll, or can be any other member that can rotate about an axis in a process direction 128 and that can transfer marking material to a media sheet.

The image generator 120 can include a marking material source 124 configured to place marking material on the rotational intermediate transfer member 122 to generate a first image and configured to place marking material on the rotational intermediate transfer member 122 to generate a second image spaced an interdocument zone distance from the first image.

The image generator 120 can include an image transfer station 126 configured to generate the first image by transferring the first image from the rotational intermediate transfer member 122 to the first media sheet 111 traveling in the media path 110 and configured to generate the second image by transferring the second image from the rotational intermediate transfer member 122 to the second media sheet 112 consecutive to the first media sheet 111, the second media sheet 112 traveling in the media path 110 a first distance x_{d1} from the first media sheet 111, the first distance x_{d1} corresponding to the interdocument zone. For example, the image transfer station 126 can transfer a latent image from a photoreceptor to a media sheet, can transfer a latent ink image to a media sheet, can transfer a latent toner image to a media sheet, or can transfer any other latent image that requires fusing to a media sheet.

To elaborate, marking material, such as toner or ink, can be placed on a rotational intermediate transfer member 122, such as an intermediate transfer roll or belt. The marking material can be transferred from the rotational intermediate transfer 122 member to a media sheet at a transfer station 126. The printing apparatus 100 can create an interdocument zone between images on the rotational intermediate transfer member 122 to provide for printing apparatus operations between images on the rotational intermediate transfer member 122. Thus, media sheets can have a corresponding spacing between them to account for the interdocument zone on the rotational intermediate transfer member 122 when images are transferred from the rotational intermediate transfer member 122 to the media sheets at the transfer station 126. Then, after the images are transferred, the first distance x_{d1} between the first media sheet 111 and the second media sheet 112 can be reduced to a second distance x_{d2}.

Some embodiments can reduce acoustic noise due to nip impact of warm pressure fusers, cold pressure fusers, hard fuser rolls and drums, and other fusers in the interdocument zone. To smoothen the impulse in the interdocument zone, the interdocument zone length can be reduced and/or minimized by running a fuser at a lower speed than the speed of a printing system, such as a xerographic system. This can minimize high frequency components of vibration. For damping of the residual vibration, a fuser roll can include an internal structure with a highly vibration-damping material such as sand or other granular material, which can assist with the damping of acoustic noise.

For example, a frequency spectrum analysis of square wave impulses shows various higher harmonics. If the impulse is smoothened to a triangular wave of same temporal duration, the higher harmonics are reduced. Thus, acoustic vibrations due to the sudden closing of a fuser nip when a media sheet's trailing edge leaves the fuser nip can be mitigated by smoothening the closure of the fuser nip as the media sheet exits. This can be done by minimizing the gap between two sheets to create a minimum amount of variation in the fuser nip opening. A small gap between the sheets can act as a dent similar to a triangular-shaped impulse. For example, a gap of less than 1 mm between the sheets can be used, depending on the weight of the media sheets.

As a further example, interdocument zones are required in some printing devices for process control. These interdocument zones can be as large as several centimeters, depending on the particular engine. In order to minimize the interdocument zone gap in a fuser, the fuser can run at a lower speed to compensate for the reduced gap and to make sure the process is synchronous along the entire media sheet path.

The printing apparatus 100 can include a variety of elements for reducing the first distance x_{d1} between the first media sheet 111 and the second media sheet 112 to a second distance x_{d2} and for reducing the first velocity v₁ of the first media sheet 111 and second media sheet 112 to a second velocity v₂. For example, the printing apparatus 100 can include a media sheet distance reduction module that can have a first conveyor belt 151 and a second conveyor belt 152 that can carry out the sequential deceleration of the sheets. The belts can be of an effective length, can be a distance apart, and can be independently controllable to reduce the distance and velocity depending on the length of the media sheets in their travel direction. For example, the first conveyor belt 151 can operate to transport the first media sheet 191 at the first velocity v₁ and the second conveyor belt 152 can operate to transport the first media sheet 191 at the second velocity v₂.

As another alternative, the media sheet distance reduction module can have one belt 151 that can be used to adjust the distance and the velocity in conjunction with rolls at the transfer station 126 and/or rolls at the fuser 140. For example, rolls or other transport mechanisms in the image generator 120 can operate to transport the first media sheet 111 at the first velocity v₁ and the first conveyor belt 151 can operate to transport the first media sheet 191 at the second velocity v₂. As a further alternative, rolls at the fuser 140 can rotate at an appropriate velocity to reduce the distance and the velocity of the first sheet 191 so the second sheet 192 enters the fuser nip at a desired distance from the first sheet 191 without using conveyor belts. Furthermore, the media sheet distance reduction module can include any other elements, such as additional rolls, belts, air devices, physical sheet stops, or other elements used to control media sheet travel, to adjust the distance between the media sheets and the velocity of the media sheets. The media sheet reduction module can be located anywhere in the printing apparatus 100. For example, the media sheet reduction module can be located before the image generator 120, can be located between the image generator 120 and the fuser 140, can be located after the fuser 140, can be located between the fuser 140 and other elements after the fuser 140, such as compilers, stackers, and/or staplers (not shown).

Thus, the media sheet distance reduction module can reduce a first distance x_{d1} between the tail edge 116 of the first media sheet 111 and the lead edge 115 of the second media sheet 112 to a second distance x_{d2} between a tail edge of the first media sheet 191 and a lead edge of the second media sheet 192. Then the first media sheet 191 and the second media sheet 192 can continue to travel along the media path 110 after the first distance x_{d1} is reduced to the second distance x_{d2}. This continuation of travel is herein defined as the first media sheet 191 continuing to travel and the second media sheet 191 continuing to travel prior to any combining of the media sheets. Such combining can include stacking, compiling, stapling, or any other combining of media sheets. Thus, the media sheets continue their current movement, such as a continuous linear non-zero velocity movement, at the second velocity v₂ after the first distance x_{d1} is reduced to the second distance x_{d2}.

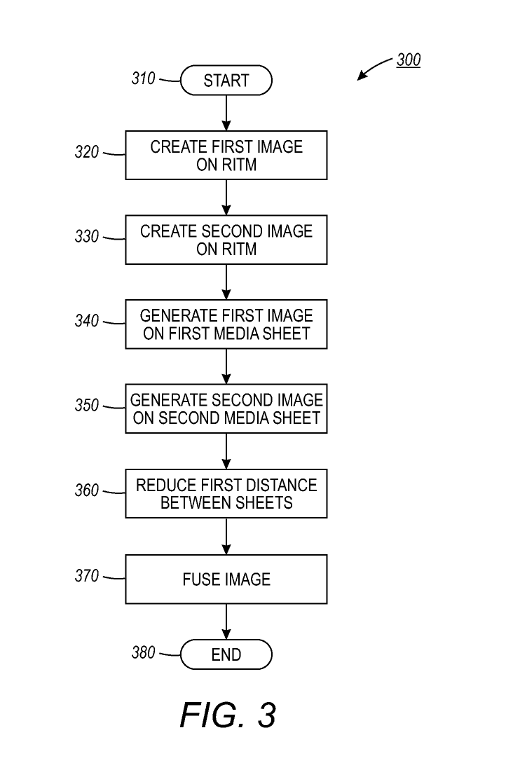

FIG. 3 illustrates an exemplary flowchart 300 of a method in a printing apparatus having a media path, an image generator, and a fuser. The fuser can include a first roll including a vibration damping material. The image generator can include a rotational intermediate transfer member and an image transfer station. The method can start at 310.

At 320, marking material can be placed on the rotational intermediate transfer member to create a first image on the rotational intermediate transfer member. At 330, marking material can be placed on the rotational intermediate transfer member to create a second image spaced an interdocument zone distance from the first image on the rotational intermediate transfer member.

At 340, a first image can be generated, using the image generator, on a first media sheet traveling in the media path. The first media sheet can travel in the media path at a first velocity when the first image is generated on the first media sheet. The first image can be generated by transferring the first image from the rotational intermediate transfer member to the first media sheet traveling in the media path.

At 350, a second image can be generated, using the image generator, on a second media sheet traveling in the media path consecutive to and a first distance from the first media sheet. The second media sheet can travel in the media path at the first velocity at the first distance from the first media sheet when the second image is generated on the second media sheet. The second image can be generated by transferring the second image from the rotational intermediate transfer member to the second media sheet consecutive to the first media sheet, where the second media sheet can be traveling in the media path a first distance from the first media sheet, the first distance corresponding to the interdocument zone.

At 360, the first distance between the first media sheet and the second media sheet can be reduced to a second distance between the first media sheet and the second media sheet after generating the first image. The first distance can be reduced to a second distance after generating the first image to reduce a length of an interdocument zone between the first media sheet and the second media sheet after generating the first image. The first distance can be reduced to a second distance after generating the first image to reduce vibration of the fuser occurring between a trailing edge of the first media sheets and a leading edge of the second media sheet.

The first velocity of the first media sheet can be reduced to a second velocity when reducing the distance between the media sheets. The first velocity of the second media sheet can also be reduced to the second velocity. The first velocity of the first media sheet can be reduced to a second velocity according to a formula based on at least:

v₁/v₂=x₁/x₂

Where v₁ can be the first velocity, v₂ can be the second velocity, x₁ can be a first length corresponding to the first distance between the first media sheet and the second media sheet, and x₂ can be a second length corresponding to the second distance between the first media sheet and the second media sheet. The first length can be determined based on a distance between a leading edge of the first media sheet and a leading edge of the second media sheet. The first length can also be determined based on a distance between a trailing edge of the first media sheet and a leading edge of the second media sheet or can be determined based on any other useful relative distance between the media sheets.

At 370, the second image can be fused to the second media sheet after reducing the first distance between the first media sheet and the second media sheet. The second image can be fused to the second media sheet traveling at the second velocity. The first image can also be fused to the first media sheet traveling at the second velocity. At 380, the method can end.

According to some embodiments, all of the blocks of the flowchart 300 are not necessary. Additionally, the flowchart 300 or blocks of the flowchart 300 may be performed numerous times, such as iteratively. For example, the flowchart 300 may loop back from later blocks to earlier blocks. Furthermore, some blocks can be performed concurrently or in parallel processes.

Although the above description is generally directed toward a fuser used in xerographic printing, it will be understood that the teachings and claims herein can be applied to any treatment of marking material on a medium. For example, the marking material may comprise liquid or gel ink, and/or heat- or radiation-curable ink; and/or the medium itself may have certain requirements, such as temperature, for successful printing. The heat, pressure and other conditions required for treatment of the ink on the medium in a given embodiment may be different from those suitable for xerographic fusing. As used herein, any such marking material-to-media affixation processing shall be considered “fusing,” regardless of its exact nature.

Embodiments may be implemented on a programmed processor. However, the embodiments may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the embodiments may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the embodiments. For example, one of ordinary skill in the art of the embodiments would be enabled to make and use the teachings of the disclosure by simply employing the elements of the independent claims. Accordingly, the embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. Also, relational terms, such as “top,” “bottom,” “front,” “back,” “horizontal,” “vertical,” and the like may be used solely to distinguish a spatial orientation of elements relative to each other and without necessarily implying a spatial orientation relative to any other physical coordinate system. The term “coupled,” unless otherwise modified, implies that elements may be connected together, but does not require a direct connection. For example, elements may be connected through one or more intervening elements. Furthermore, two elements may be coupled by using physical connections between the elements, by using electrical signals between the elements, by using radio frequency signals between the elements, by using optical signals between the elements, by providing functional interaction between the elements, or by otherwise relating two elements together. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A method in a printing apparatus, the printing apparatus including a media path, an image generator, and a fuser, the method comprising:
generating, using the image generator, a first image on a first media sheet traveling in the media path;
generating, using the image generator, a second image on a second media sheet traveling in the media path consecutive to and a first distance from the first media sheet;
reducing the first distance between the first media sheet and the second media sheet to a second distance between the first media sheet and the second media sheet after generating the first image; and
fusing the second image to the second media sheet after reducing the first distance between the first media sheet and the second media sheet.

2. The method according to claim 1,
wherein generating a first image comprises generating the first image on the first media sheet traveling in the media path at a first velocity, and
wherein the method comprises reducing the first velocity of the first media sheet to a second velocity after generating the first image.

3. The method according to claim 2, wherein the first velocity of the first media sheet is reduced to a second velocity according to a formula based on at least:
v₁/v₂=x₁/x₂
where:
v₁ comprises the first velocity,
v₂ comprises the second velocity,
x₁ comprises a first length corresponding to the first distance between the first media sheet and the second media sheet, and
x₂ comprises a second length corresponding to the second distance between the first media sheet and the second media sheet.

4. The method according to claim 3, wherein the first length is determined based on a distance between a leading edge of the first media sheet and a leading edge of the second media sheet.

5. The method according to claim 3, wherein the first length is determined based on a distance between a trailing edge of the first media sheet and a leading edge of the second media sheet.

6. The method according to claim 1, wherein the fuser comprises a first roll including a vibration damping material.

7. The method according to claim 1, wherein reducing comprises reducing the first distance between the first media sheet and the second media sheet to a second distance between the first media sheet and the second media sheet after generating the first image to reduce vibration of the fuser occurring between a trailing edge of the first media sheets and a leading edge of the second media sheet.

8. The method according to claim 1, wherein reducing comprises reducing the first distance between the first media sheet and the second media sheet to a second distance between the first media sheet and the second media sheet after generating the first image to reduce a length of an interdocument zone between the first media sheet and the second media sheet after generating the first image.

9. The method according to claim 8,
wherein the image generator comprises a rotational intermediate transfer member and an image transfer station, and
wherein the method further comprises:
placing marking material on the rotational intermediate transfer member to create a first image on the rotational intermediate transfer member; and
placing marking material on the rotational intermediate transfer member to create a second image spaced an interdocument zone distance from the first image on the rotational intermediate transfer member,
wherein generating the first image comprises transferring the first image from the rotational intermediate transfer member to the first media sheet traveling in the media path, and
wherein generating the second image comprises transferring the second image from the rotational intermediate transfer member to the second media sheet consecutive to the first media sheet, the second media sheet traveling in the media path a first distance from the first media sheet, the first distance corresponding to the interdocument zone.

10. A printing apparatus comprising:
a media path configured to transport a first media sheet and a second media sheet consecutive to the first media sheet;
an image generator configured to generate a first image on the first media sheet traveling in the media path and configured to generate a second image on the second media sheet traveling in the media path consecutive to and a first distance from the first media sheet;
a controller configured to control the printing apparatus to reduce the first distance between the first media sheet and the second media sheet to a second distance between the first media sheet and the second media sheet after generating the first image; and
a fuser configured to fuse the second image to the second media sheet after the first distance is reduced between the first media sheet and the second media sheet.

11. The printing apparatus according to claim 10,
wherein the image generator is configure to generate the first image on the first media sheet traveling in the media path at a first velocity, and
wherein the controller is configured to control the printing apparatus to reduce the first velocity of the first media sheet to a second velocity after generating the first image, and
wherein the fuser is configured fuse the first image to the first media sheet after reducing the first velocity of the first media sheet to a second velocity.

12. The printing apparatus according to claim 11, wherein the first velocity of the first media sheet is reduced to a second velocity according to a formula based on at least:
v₁/v₂=x₁/x₂
where:
v₁ comprises the first velocity,
v₂ comprises the second velocity,
x₁ comprises a first length corresponding to the first distance between the first media sheet and the second media sheet, and
x₂ comprises a second length corresponding to the second distance between the first media sheet and the second media sheet.

13. The printing apparatus according to claim 10, further comprising a media sheet distance reduction module including at least one belt located in the media path between the image generator and the fuser, the at least one belt configured to reduce the first distance between the first media sheet and the second media sheet to the second distance between the first media sheet and the second media sheet after the image generator generates the first image.

14. The printing apparatus according to claim 10, wherein the fuser comprises a first roll including a vibration damping material.

15. The printing apparatus according to claim 10, wherein the controller is configured to control the printing apparatus to reduce the first distance between the first media sheet and the second media sheet to a second distance between the first media sheet and the second media sheet after generating the first image to reduce vibration of the fuser occurring between a trailing edge of the first media sheets and a leading edge of the second media sheet.

16. The printing apparatus according to claim 10, wherein the controller is configured to control the printing apparatus to reduce the first distance between the first media sheet and the second media sheet to a second distance between the first media sheet and the second media sheet after generating the first image to reduce a length of an interdocument zone between the first media sheet and the second media sheet after generating the first image.

17. The printing apparatus according to claim 16,
wherein the image generator comprises:
a rotational intermediate transfer member;
a marking material source configured to place marking material on the rotational intermediate transfer member to generate a first image and configured to place marking material on the rotational intermediate transfer member to generate a second image spaced an interdocument zone distance from the first image,
and an image transfer station configured to generate the first image by transferring the first image from the rotational intermediate transfer member to the first media sheet traveling in the media path and configured to generate the second image by transferring the second image from the rotational intermediate transfer member to the second media sheet consecutive to the first media sheet, the second media sheet traveling in the media path a first distance from the first media sheet, the first distance corresponding to the interdocument zone.

18. A printing apparatus comprising:
a media path configured to transport a first media sheet and a second media sheet consecutive to the first media sheet;
an image generator configured to generate a first image on the first media sheet traveling in the media path and configured to generate a second image on the second media sheet traveling in the media path consecutive to the first media sheet;
a media sheet distance reduction module configured to reduce a first distance between the first media sheet and the second media sheet to a second distance between the first media sheet and the second media sheet; and
a controller configured to control the media sheet distance reduction module to reduce a first distance between the first media sheet and the second media sheet to a second distance between the first media sheet and the second media sheet.

19. The printing apparatus according to claim 18, wherein the media sheet distance reduction module comprises a belt configured to reduce the first distance between the first media sheet and the second media sheet to the second distance between the first media sheet and the second media sheet.

20. The printing apparatus according to claim 18,
wherein the media sheet distance reduction module reduces a first distance between a tail edge of the first media sheet and a lead edge of the second media sheet to a second distance between the tail edge of the first media sheet and the lead edge of the second media sheet, and
wherein the lead edge of the second media sheet and the first media sheet and the second media sheet continue to travel along the media path after the first distance is reduced to the second distance.
